(19) United States
(12) Patent Application Publication
(10) Pub. No.: US 2005/0203651 A1
(43) Pub. Date: Sep. 15, 2005

(54) System and process for charting the time and position of a contestant in a race

(76) Inventor: Fernando Vincenzini, Glen Cove, NY (US)

Correspondence Address: WILLIAM COLLARD;COLLARD & ROE, P.C., 1077 NORTHERN BOULEVARD, ROSLYN, NY, 11576, US

(21) Appl. No.: 11/126,736

(22) Filed: May 11, 2005

Related U.S. Application Data
(63) Continuation-in-part of application No. 10/860,867, filed on Jun. 3, 2004.
Application No. 10/860,867 is a continuation-in-part of application No. PCT/US02/38459, filed on Dec. 3, 2002.
(60) Provisional application No. 60/336,620, filed on Dec. 3, 2001.
(60) Provisional application No. 60/577,430, filed on Jun. 3, 2004.

(51) Int. Cl. A63F 13/00

(52) U.S. Cl. 700/91

(57) ABSTRACT

A system and a process for determining the timing and position of contestants on a track. This system comprises at least one loop that has a longitudinal axis that projects from an inside rail to an outside rail on the track. There is also at least one competitor communication device that can be coupled to each contestant. There is a remote base station, which is in communication with the positioning device, wherein the positioning device determines a contestant time as the contestant passes the wire loop and also determines the position of the contestant in relation to an inside guide such as a rail. A relay positioned in the center of the track can also be used to increase the signal flowing between the base station and the positioning device. The process for determining the position and timing of each contestant in a race includes the steps of attaching at least one competitor communication device on at least one individual contestant. Next, the race starts, whereby during the race, the position and time for each contestant is recorded. Next a signal is transmitted from the competitor communication device to a remote base station. Finally, these signals are synchronized so that there is no interference.

### CROSS REFERENCE TO RELATED APPLICATIONS

This application is a Continuation in part application and claims priority under 35 U.S.C. 120 from U.S. patent application Ser. No. 10/860,867, filed on Jun. 3, 2004 wherein that application is a continuation in part application and claims priority under PCT application Ser. No. US/02/38459 filed on Dec. 3, 2002 wherein that application claims priority under 35 U.S.C. 119e from Provisional application Ser. No. 60/336,620 filed on Dec. 3, 2001, this application also claims priority under 35 U.S.C. 119e from provisional application Ser. No. 60/336,620 filed on Jun. 3, 2004 wherein the disclosures of both provisional applications the utility application and the PCT application are hereby incorporated herein by reference.

### BACKGROUND OF THE INVENTION

1. Field of the Invention

The invention relates to a system and a process for determining the time and position of a contestant in a race. More particularly, the invention relates to a system and a process for determining the times for each contestant at particular positions or splits in a race and for determining the position of each contestant in relation to an inside guide, or rail of the track at each of these particular splits.

Timing and position systems are known in the art. For example the following U.S. Patents generally disclose timing and/or positioning systems for contestants in a race: U.S. Pat. No. 6,072,751 to Kirson et al issued on Jun. 6, 2000; U.S. Pat. No. 5,844,861 to Maurer issued on Dec. 1, 1998; U.S. Pat. No. 5,737,280 to Kokubo issued on Apr. 7, 1998; U.S. Pat. No. 5,138,550 to Abraham et al issued on Aug. 11, 1992; U.S. Pat. No. 4,774,679 to Carlin issued on Sep. 27, 1988; U.S. Pat. No. 4,571,698 to Armstrong issued on Feb. 18, 1986; U.S. Pat. No. 4,274,076 to Hermanns et al. issued on Jun. 16, 1981; U.S. Pat. No. 4,142,680 to Oswald et al issued on Mar. 6, 1979; U.S. Pat. No. 3,946,312 to Oswald et al. issued on Mar. 23, 1976; U.S. Pat. No. 3,795,907 to Edwards issued on Mar. 5, 1974; and U.S. Pat. No. 3,781,529 Abramson et al. Issued on Dec. 25, 1973 wherein the disclosures of which are herein incorporated by reference.

### SUMMARY

One embodiment can be a system and a process for determining the timing and position of contestants on a track. This system comprises at least one wire loop disposed above, below or adjacent to a track, and disposed at a particular position or split on the track. There can also be at least one competitor communication device (CCD) that can be coupled to each contestant. There can also be at least one remote base station, wherein the competitor communication device determines a contestant time as the contestant passes the wire loop. The wire loop in one embodiment can be formed as two trapezoidal shaped loops that have a longitudinal axis that project from an inside rail to an outside rail on the track. On the inside rail the trapezoidal shaped loops are narrower, while on the outside rail the trapezoidal shaped loops are wider.

These trapezoidal loops create a magnetic field that has at least two nulls, wherein via reading these nulls, the position of each contestant in relation to the rail can be determined. This feature is particularly useful in determining the performance of a competitor wherein during a race, this performance will be processed and presented in real time and published for future race handicapping.

The CCD can comprise a positioning sensor in the form of a coil for reading the magnetic field from these loops. An amplifier which can be a logarithmic amplifier and a tuning capacitor may also be coupled to this coil. This sensor is coupled to a microprocessor and to a power input. The power input can be in the form of a battery that may also include a DC-DC boost converter to give the components for example, a 5V power supply. In addition, coupled to the microprocessor and the power input is a transceiver wherein there is an antenna coupled to the transceiver. In addition, a video and audio input can also be coupled to the power input and to the microprocessor.

The microprocessor can include/perform a set of instructions that creates a unique identity for the sensor unit. This unique identity allows the remote base station to track each individual contestant individually and to match the time and position of each individual contestant on the track for handicapping of a race or for race analyzation processes.

The microprocessor can also include a synchronization protocol which sets periodic transmissions of signals from at least one transceiver to the at least one remote processing or base station. This synchronization protocol can be a time division multiple access (TDMA) protocol where collision is avoided by assigning each transceiver its own time slot.

This microprocessor also controls the audio and video transmission from each contestant so that the audio and video transmission is sent from only one contestant at a time.

There is also a process for determining the position and timing of each contestant in a race. This process includes the steps of attaching at least one CCD on at least one individual contestant. Next, the race starts, whereby during the race, the position and time for each contestant is recorded. Next a signal is transmitted from the CCD to a remote base station. Finally, these signals are synchronized so that there is no interference.

In another embodiment of the invention, the CCD is a three dimensional magnetic field sensor which detects an absolute value of an ambient AC magnetic field. This absolute value depends on the sensor's position in space but not on the sensor's rotation.

The sensor consists of a plurality of XYZ coils which pick up the X, Y, and Z component of the field. The coil signals are then amplified by a set of amplifiers each connected to the XYZ coils. The amplitude of the signals fed from the amplifiers is detected by a plurality of amplitude detectors in communication with each of the amplifiers. There are then a set of analog to digital converters with at least one analog to digital converter in communication with each of the amplitude detectors. These analog to digital converters then feed into a microprocessor, which in turn calculates the absolute value of the magnetic field.

With this second embodiment, there is also a loop of wires that generate a signal to be read by a sensor. The loop of wires essentially form a trapezoidal shape along a vertical plane above or below a racetrack. The trapezoidal shape of the wires is used to determine the position of each of the sensors as the sensor crosses the wire.

In another embodiment of the invention the loops can be placed along an inside rail of a racetrack wherein these loops can be in the form of elongated loops extending along a length of the track.

In another embodiment of the invention, the loops can be extended above a racetrack wherein two loops can be disposed above competitors and extend substantially parallel to each other.

In another embodiment of the invention, there can be a loop system wherein in this embodiment, the device includes a loop that can be positioned underneath a track via a process called directional drilling. In this case, the equipment drills a tiny hole and pulls the cable through this hole so that the racetrack is not affected at all. In this embodiment, the wires can be placed approximately 1.5 meters below the track surface. Depending on improvements in technology and the conditions of the track, the depth of placement below the track surface may be adjusted. This loop can include essentially two loops with a first loop coupled to a second loop wherein both loops are driven or powered by a loop driver. These loops or loop systems can be placed around a track at any point, but may be particularly placed at fraction points around a track such as the start, the ¼ mile marker, the ½ mile marker, the ¾ mile marker and the one mile marker and the finish line if the finish line is not on a fraction line. In this case, the start position may be adjusted because races such as horse races usually adjust the starting position of the race based upon the length of the race while usually keeping a standard finish line.

Essentially, the loop can be in the shape of a large “V” with one arm perpendicular to the race track and the other arm positioned at an angle. Power can flow through the loop in a counter clockwise manner wherein this power can flow out from a loop driver and through the second loop first and then flow through the first loop and then back to the loop driver. Using a computer simulation of the magnetic field readings, the signal can be picked up by a sensor positioned in a CCD and placed either on a horse or a jockey. This signal is then relayed to a remote base station for further readings and analysis.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings wherein similar reference characters denote similar elements throughout the several views:

FIG. 1 is a perspective view of one embodiment the system installed on a track;

FIG. 2 is a top view of loops associated with the embodiment of FIG. 1;

FIG. 3 is a schematic block diagram of a first embodiment of the competitor communication device (CCD);

FIG. 4 is a schematic block diagram of a infrared receiving device;

FIG. 5 is a schematic block diagram of a remote infrared terminal associated with the second embodiment of the device shown in FIG. 4;

FIG. 6 is a graph of the magnetic reading of the device as it travels under horizontally positioned loops;

FIG. 7 is a graph of the magnetic reading of the device as it travels under vertically positioned loops;

FIG. 8 is a schematic block diagram of the remote base station;

FIG. 9 is a schematic block diagram of a second embodiment of a sensor;

FIG. 10 is a top view of a second embodiment installed on a track;

FIG. 11a is a representation of a second embodiment of the wire loop;

FIG. 11b is a representation of a third embodiment of the wire loop;

FIG. 12 is a representation of a calculation from the wire loop;

FIG. 13 is a graph of a signal reading to determine when the sensor of FIG. 9 crosses under the loop shown in FIG. 11;

FIG. 14 is a perspective view of another embodiment of a series of loops placed adjacent to an inside rail of a track;

FIG. 15 is a graph of a reading taken from a sensor interacting with the loops shown in FIG. 14;

FIG. 16A is a plan view of a section of another embodiment of the invention including a new loop;

FIG. 16B is a computer readout of the loop presented in FIG. 16A;

FIG. 17 is a block diagram of a computer system for the presentation of information;

FIG. 18 is a graphical representation which can be used to provide an instant race recap for each fraction and finish;

FIG. 19 denotes a television graphical representation of the top three (3) finishers (win, place, show) throughout a race; and

FIG. 20 shows a full field running order television screen which includes the actual live video screen of the race competitors

### DETAILED DESCRIPTION OF THE PREFERRED EMBODIMENT

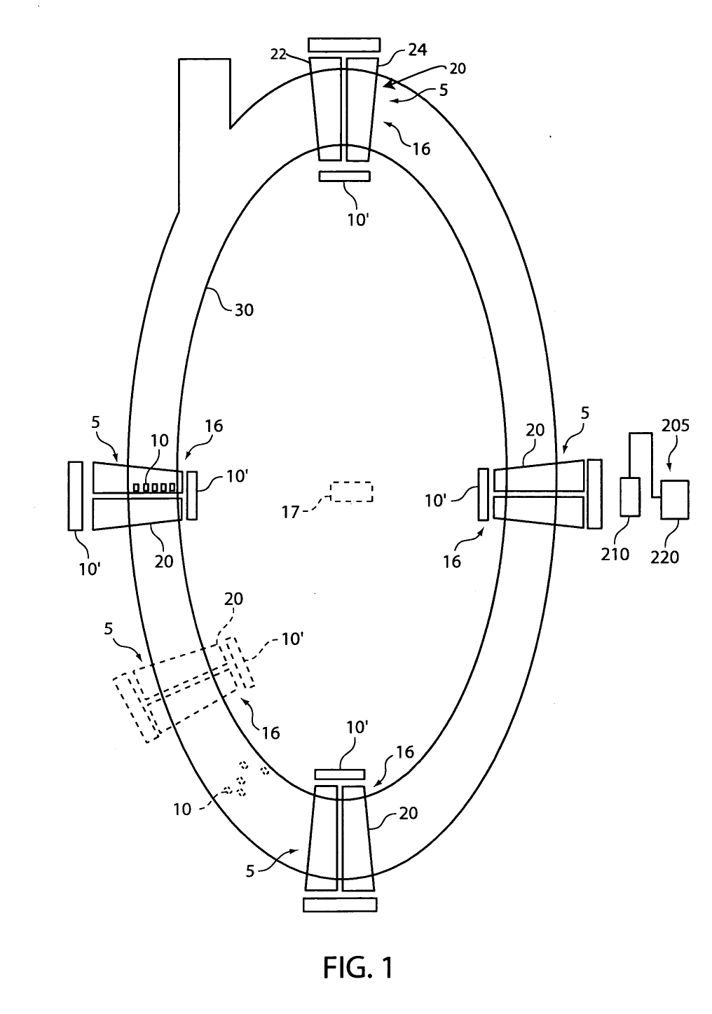

Referring to the drawings, FIG. 1 is a plan view of the system 5 which includes the (CCD) 10 which is coupled to a contestant such as a horse. There is also shown a plurality of tracking stations 16 disposed around the track. These tracking stations 16 contain a plurality of loops 20 and are in communication with a relay 17 disposed in a center region of a track. Relay 17 is for amplifying the signal generated from stations 16.

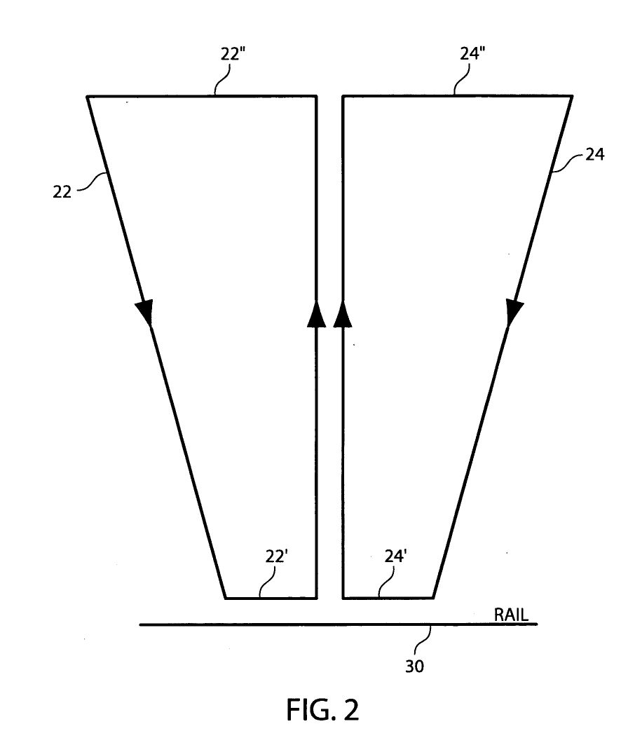

Loops 20 comprise a first trapezoidal loop 22 and a second trapezoidal loop 24. Loops 20 are held above a race track such as a horse track wherein as shown in FIG. 2, loop 22 contains an inside section 22′ that is adjacent to a rail and an outside section 22″. Inside section 22′ is narrower than outside section 22″. In addition, loop 24 includes inside section 24′ and outside section 24″. As with loop 22, inside section 24′ which is closer to the rail, is narrower than outside section 24″.

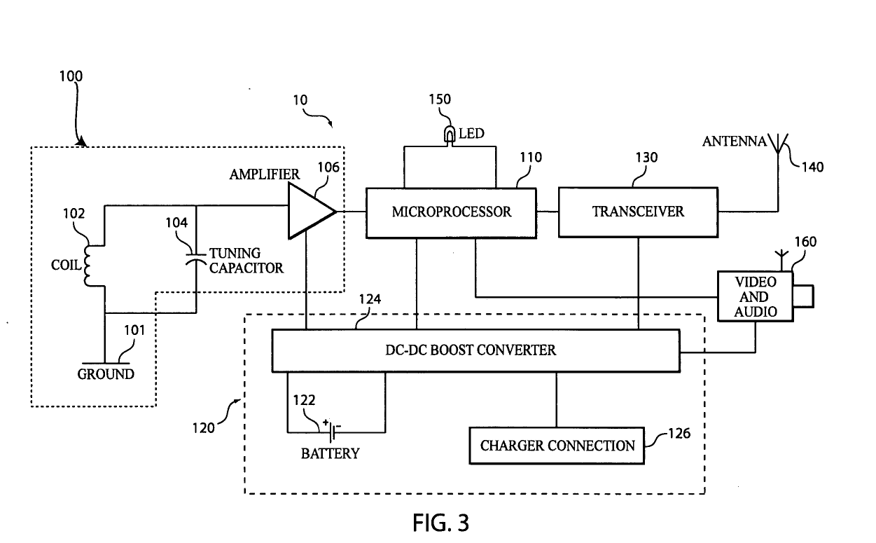

FIG. 3 shows a schematic block diagram of the CCD 10. This device comprises a position sensor 100 which includes a coil 102, a tuning capacitor 104 and an amplifier 106. Position sensor 100 interacts with magnetic fields created by loops 22 and 24 on the track to determine the position and time of the individual contestant at a particular period of time during the race. Coil 102 is positioned along the X-axis, so that it can read the nulls that occur in the X-component of the magnetic field generated by the loops.

Microprocessor 110 is coupled to amplifier 106, whereby microprocessor 110 contains instructions to control the transfer of signals, the individual timing of the contestant, and to carry a unique identifier to identify each individual contestant.

Coupled to microprocessor 110 is transceiver 130, which can send and receive signals from microprocessor 110 through antenna 140 to and from a base station. There is also a power input 120 which is coupled to amplifier 106, microprocessor 110, transceiver 130, and video and audio input 160. Power input 120 comprises a battery 122, a DC-DC boost converter 124 and a charger connection 126. Battery 122 sends power through DC-DC boost converter 124 such that converter 124 delivers 5V of power supply into the components in the system. Charger connection 126 works in unison with LED 150 and battery 122 so that when battery 122 runs down, LED 150 changes from green to red to indicate that the battery is running out of power. Conversely, once the battery has been fully recharged, LED 150 changes color back from red to green to indicate a full charge.

Video and Audio input 160 is essentially a motion video camera with a microphone that can be placed on a contestant such as a horse. With a horse, the camera would most likely be placed on the back of a saddle to capture moving images behind the horse. Microprocessor 110 would then control the sending of this information to a remote base station depending on instructions sent from that remote base station.

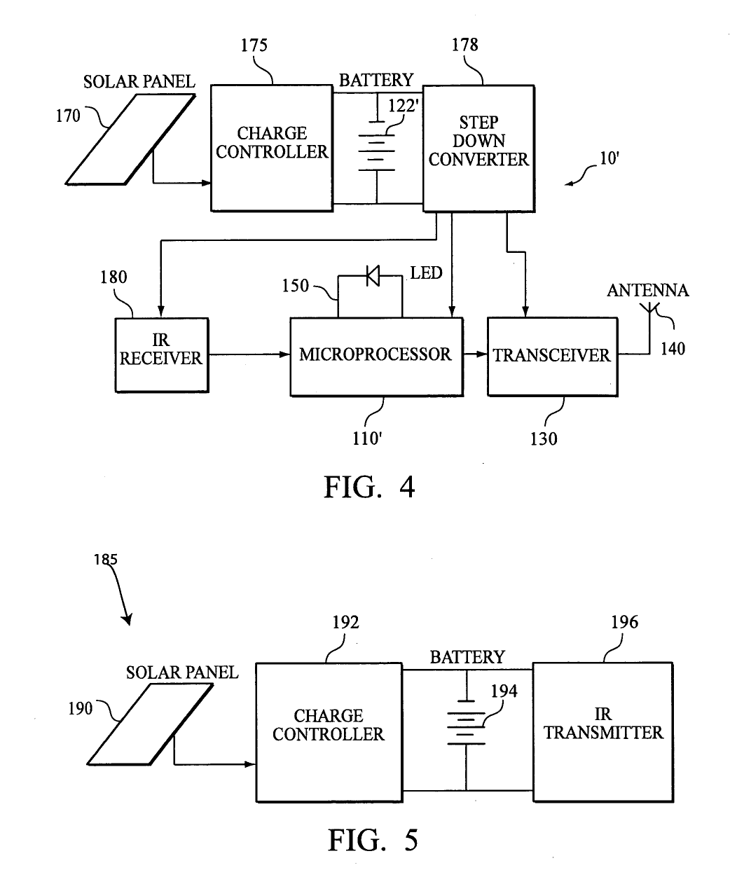

FIG. 4 shows an embodiment of the infrared tracking system 10′ (See also FIG. 1). This tracking system 10′, includes solar power in the form of a solar powered panel 170 fixed into the system. Panel 170 is coupled to charge controller 175. Charge controller 175 is coupled to battery 122′. Both charge controller 175 and battery 122′ are coupled to step down converter 178. Step down converter 178 converts the energy input from both charge controller 175 and battery 122′ into usable energy for the remaining components. These components include microprocessor 110′ which functions similar to microprocessor 110, and transceiver 130 which is essentially identical to transceiver 130 in FIG. 3. In addition, antenna 140 is coupled to transceiver 130 as well. This device can also include an LED indicator 150′ which is similar to LED indicator 150 and indicates whether the device is charged and/or running.

With this embodiment, there is an infrared or IR receiver 180 coupled to microprocessor 110′. IR receiver 180 is used as a position sensor to determine the time and position of the individual contestant as that contestant is racing in a race. Essentially, IR receiver 180 receives an infrared beam from IR transmission device 185. IR receiver 180 and IR transmission device 185 are positioned at a start pole on opposite sides of the track, so that at the start of the race, these devices can track the exact start of the race by having the competitors cross the IR beam being sent between transmission device 185 and receiving device 180. Thus when the race starts, this beam is broken and then a signal is sent to a base station to start the race clock.

As shown in FIG. 5, IR transmission device 185 includes solar panel 190, a charge controller 192 for controlling the charge from solar panel 190, a battery 194 and an IR transmitter 196 for transmitting position signals to and from each contestant.

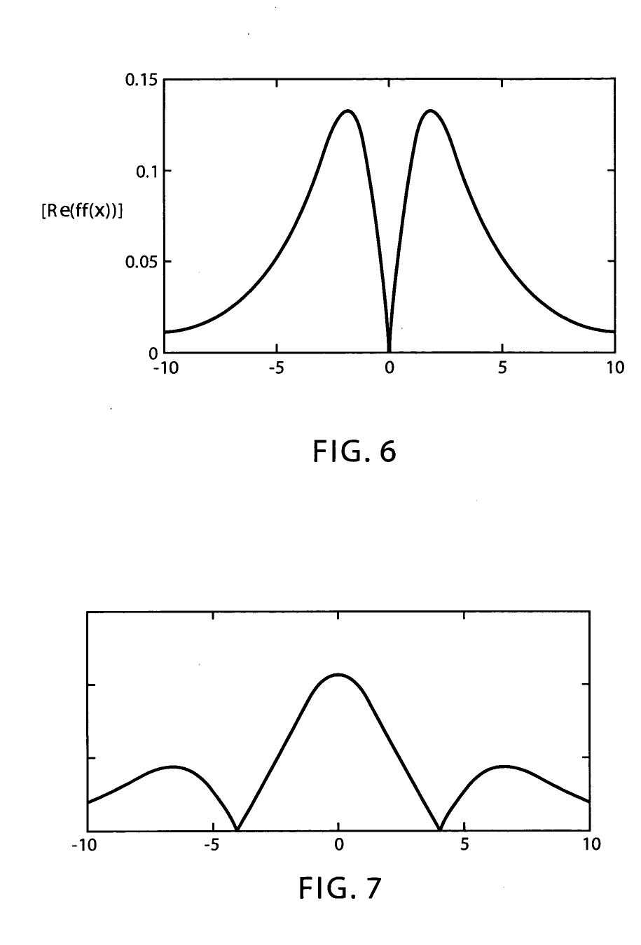

FIG. 6 shows the X-component of the field read by the CCD 10 as it passes a single section loop. A two-section loop as in FIG. 2 will produce the readout of FIG. 7. The narrower the loop, the closer will be the nulls on FIG. 7. With a trapezoidal loop, the distance between nulls that the CCD reads will be proportional to its distance from the rail.

Because there is both an IR based system and a magnetic based system at each terminal, this provides a redundant system for tracking the race contestants. The IR based system does not contain information relating to the identity of each contestant. However, the IR based system does relay the time that the first competitor crosses each mark. Thus, at a very minimum, this IR based system can be used to verify the start and ending times of a race.

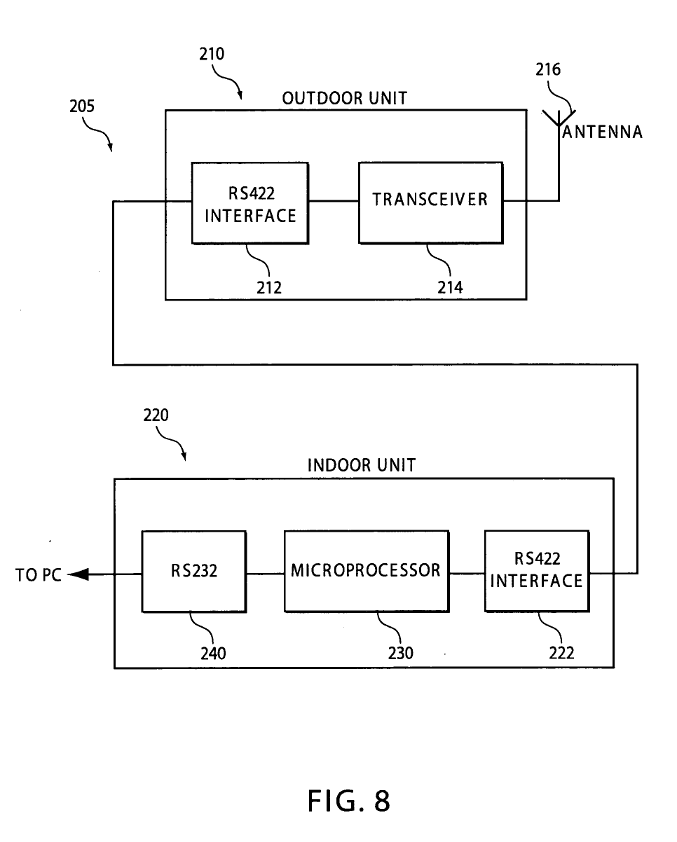

FIG. 8 is a schematic block diagram of a base station 205 which is also shown in FIG. 1. Base station 205 includes an outdoor unit 210 and an indoor unit 220. Outdoor unit 210 includes an RS422 interface which is coupled to a transceiver 214. Transceiver 214 is also coupled to an antenna 216 which is designed to receive signals from antenna 140 on device 10. Essentially information in the form of signals flows into antenna 216 from one or more devices 10 during a race. This information is sent through transceiver 214 and then through RS422 interface 212 and then onto indoor unit 220. Indoor unit 220 also includes a RS422 interface 222 and a microprocessor 230. Essentially, these RS 422 interfaces allow communication between the outdoor and indoor devices via appropriate cabling. Microprocessor 230 reads and identifies these signals and also sends signals back through outdoor unit 210 to control the protocol and sending of transmissions from devices 10. Information from microprocessor 230 is then sent on to RS 232 interface 240 which then transfers this information on to a personal computer for transmission to an internet site or to post results internally for handicapping.

The system operates as follows: each contestant receives a competitor communication device 10 which can be attached to each contestant by any known means such as a belt, a strap, etc. This device is turned on and it may run one or more test signals to base station 205 so that each device 10 is pretested to communicate with base station 205. Each contestant lines up at a starting line which contains loops 20 and the infrared system which projects an infrared beam. A race indicator goes off whereby the contestants are notified of the start of the race. This start may occur via a gun, bell, or a horn sounding. As the first contestant passes and breaks the infrared beam, a signal is sent to base station 205 indicating the start of the race. This breaking of the infrared beam starts the race clock. Next, as each contestant crosses a null period in the magnetic field created by loops 20, this causes a second signal to be sent to base station 205 for each contestant. This second signal starts the individual race clocks for each contestant. Thus, there are many clocks running at one time. First, there is a universal race clock which determines the universal race time. There are also individual clocks that determine the split times for each competitor's split. These separate times are useful because it allows the analyzation of the true starting times for each contestant. Thus, if a contestant is quick off of the start there will be little or no time lag between the universal race time and that individual competitor's race time. However, if the contestant is slow off the start, then there will be a large or even larger time lag for that competitor.

As each contestant or competitor crosses each of the splits, the times for each contestant is sent to base station 205. In addition, when the first contestant crosses that split station, the infrared system sends a signal for the race split as well. All of the competitors race around the track until they reach the finish line whereby as they reach the finish line, their times are clocked into base station 205. The overall winning race time stops when the first competitor crosses the infrared beam of the finish line.

During this race, the position of each individual contestant is also recorded. The position of each contestant at each split is also sent to base station 205 and recorded. In addition, during this entire race, base station 205 is controlling processor 110 in competitor communication device 10 to determine whether to send audio and video signals. In addition, base station 205 is sending controlling signals for the transmission of this information via a synchronized relay system explained above so that there is no interference of signals from any of the CCDs.

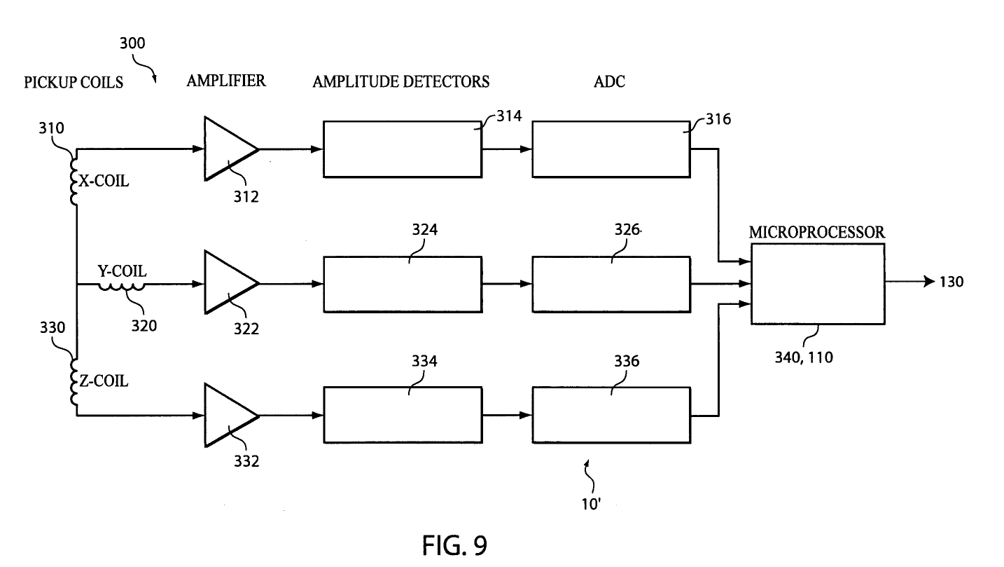

FIG. 9 is a schematic block diagram of a second embodiment of a sensor or CCD 300 which contains an x coil 310, a y coil 320 and a z coil 330. An amplifier 312, is in communication with x coil 310 while an amplifier 322 is in communication with y coil 320 while a third amplifier 332 is in communication with z coil 330. There is also a set of amplitude detectors 314, 324 and 334 with amplitude detector 314 in communication with amplifier 312, amplitude detector 324 in communication with amplifier 322, and amplitude detector 334 in communication with amplifier 332. A set of analog to digital converters (ADC) 316, 326, and 336 are also coupled to the amplitude detectors 314, 324, and 334 respectively. With this connection, ADC 316 is in communication with amplitude detector 314, ADC 326 is in communication with amplitude detector 316, and ADC 336 is in communication with amplitude detector 326. Finally, a microprocessor 340 is in communication with ADCs 316, 326 and 336 at a downstream end. Microprocessor 340 then can communicate with a transceiver 130 at a downstream end so that this information can be communicated onward to the appropriate base stations.

The sensor operates as follows, x, y, and z components of a signal are picked up by x, y, and z coils 310, 320 and 330 respectively. The components of this signal are fed from these coils into their respective amplifiers 312, 322, and 332. The coil signals are amplified by the amplifiers and then the amplitude of each of these signals is obtained by the amplitude detectors 314, 324, and 334 respectively. These amplitudes are then digitized by the ADCs 316, 326, and 336 respectively wherein this information is fed into microprocessor 340.

The microprocessor then calculates the absolute value of the magnetic field using a program that follows the following formula:
B=\sqrt{bx²+by²+bz²}

Where:
B is the total magnitude of the field
Bx, By and Bz are the magnitudes read by the x, y and z coils respectively. Because of these three coils extending in the three dimensions are used, these coils can be used to determine the position of each party.

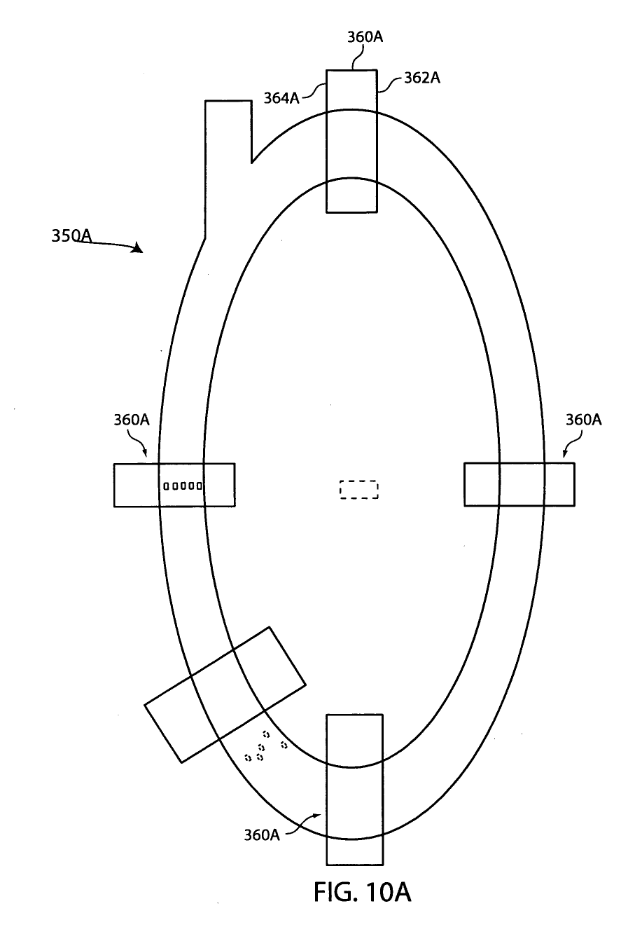

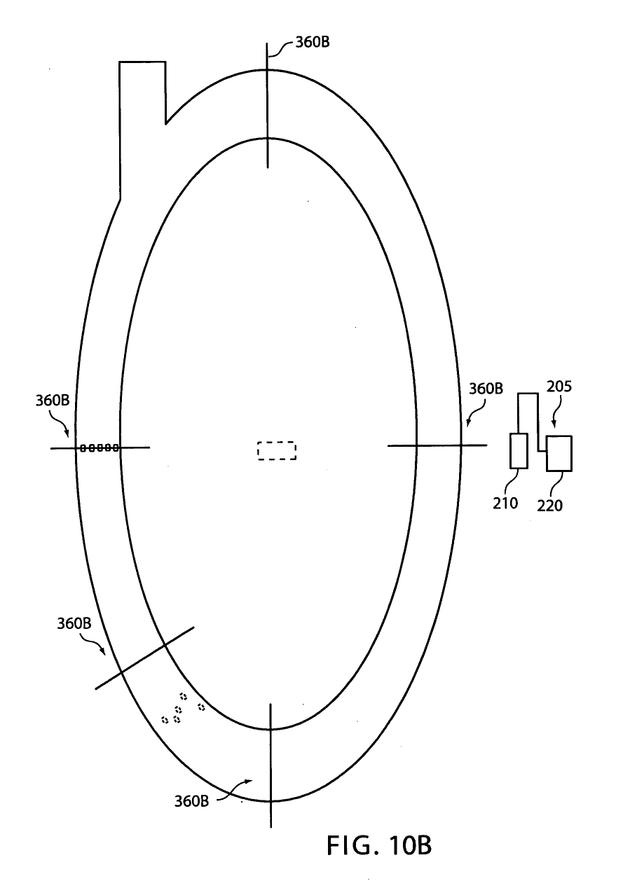

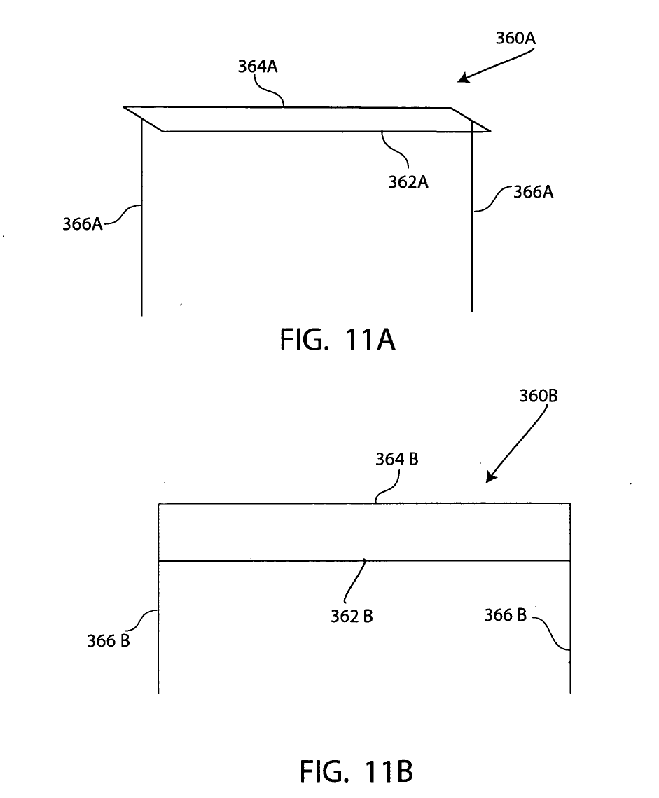

FIG. 10A is a top view of a second embodiment of a track system 350A which shows loops 360A disposed at different locations about the track. Loops 360A are spaced above the track and extend from the rail to the outside of the track as shown in FIG. 11A. Loop 360A essentially contains a first wire 362A and a second wire 364A wherein first wire 362A and second wire 364A are elevated above a track via elevation poles 366A.

FIG. 10B is a top view of a third embodiment of a track 350B which shows vertical loops 360B disposed at different locations about the track. Loops 360B are substantially rectangular shaped loops as shown in FIG. 11B. Loop 360B contains a first wire 362B and a second wire 364B which are elevated above a track via elevation poles 366B.

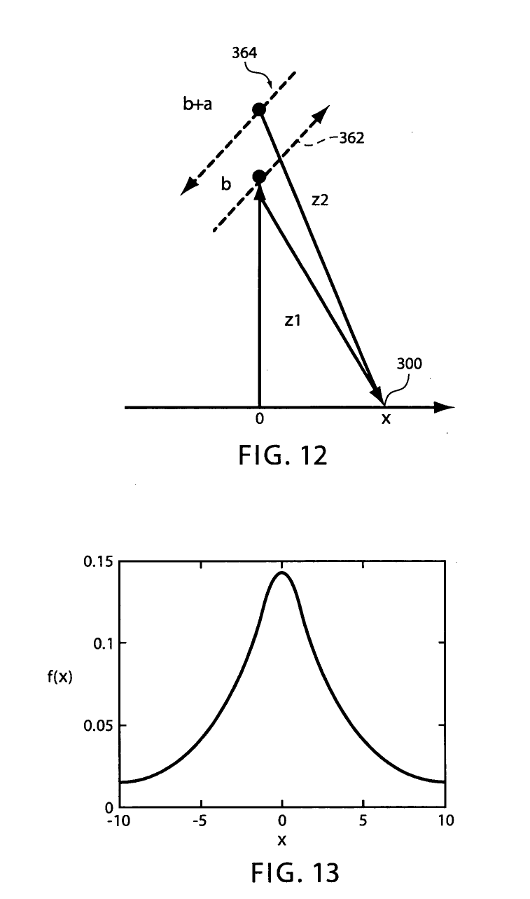

FIG. 12 shows a diagram used to derive a formula for the magnetic field under a vertical loop, with first wire 362 positioned at a first height b and second wire 264 positioned at a second height b+a. Both of these wires are spaced apart respect to a position of a sensor 300 by a distance z1 for wire 362 and z2 for wire 364 wherein sensor 300 is positioned from elevation poles 366 by a distance x.

The vectors z1 and z2 from the two wires to point x are z1=x−ib and z2=x−i(b+a).

If the loop current is I, the magnetic field produced by each of the wires will be:

$$B1 = \frac{2 I {μ}_{0}}{4 π} ( - i \frac{z1}{{\vert z1 \vert}^{2}} ) and B = \frac{2 I {μ}_{0}}{4 π} f ( a , b , x )$$

Thus the resulting field B will then be the sum of fields B1 and B2:

$$B2 = \frac{2 I {μ}_{0}}{4 π} ( i \frac{z2}{{\vert z2 \vert}^{2}} )$$

The sensor will then be used to detect |B|. After substituting z1 and z2 and doing the math, the formula for the absolute value of B as a function of the sensor position x is:

$$\begin{matrix}B = \frac{2 I {μ}_{0}}{4 π} ( - i \frac{z1}{{\vert z1 \vert}^{2}} + i \frac{z2}{{\vert z2 \vert}^{2}} ) or \\ B ( x ) = \frac{2 I {μ}_{0}}{4 π} \frac{a}{\sqrt{( {x}^{2} + {b}^{2} ) ( {x}^{2} + {( b + a )}^{2} )}}\end{matrix}$$

where:

$$f ( a , b , x ) = \frac{a}{\sqrt{( {x}^{2} + {b}^{2} ) ( {x}^{2} + {( b + a )}^{2} )}}$$

is a function of the sensor position x, the loop height above sensor b, and a loop width a.

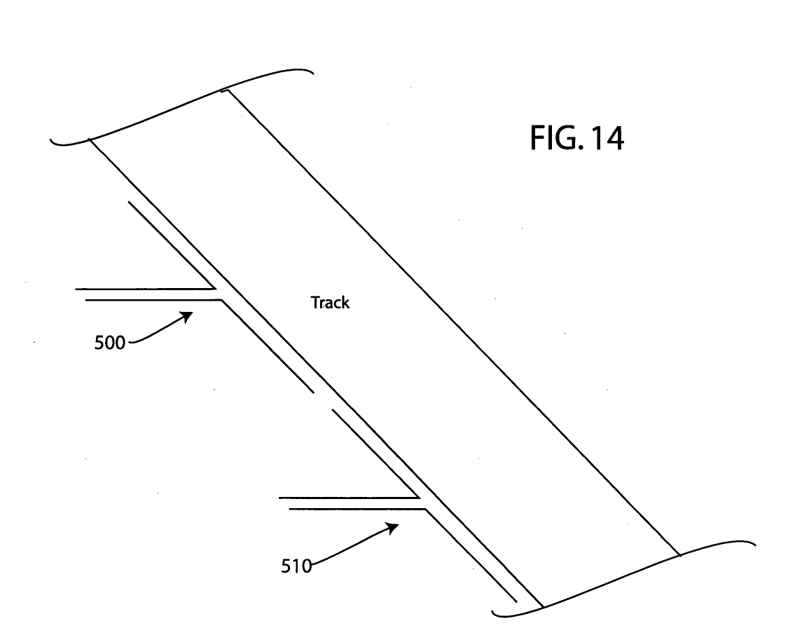

FIG. 13 is a graph of a signal reading to determine when the sensor of FIG. 9 crosses under the loop shown in FIGS. 11A or 11B. This graph shows a reading for the function f(x) described above wherein b=2.6 meters and a=1.5 meters. Microprocessor 340 can then easily read the peak of this function to determine the timing and position of sensor 300 as sensor 300 passes loop 360.

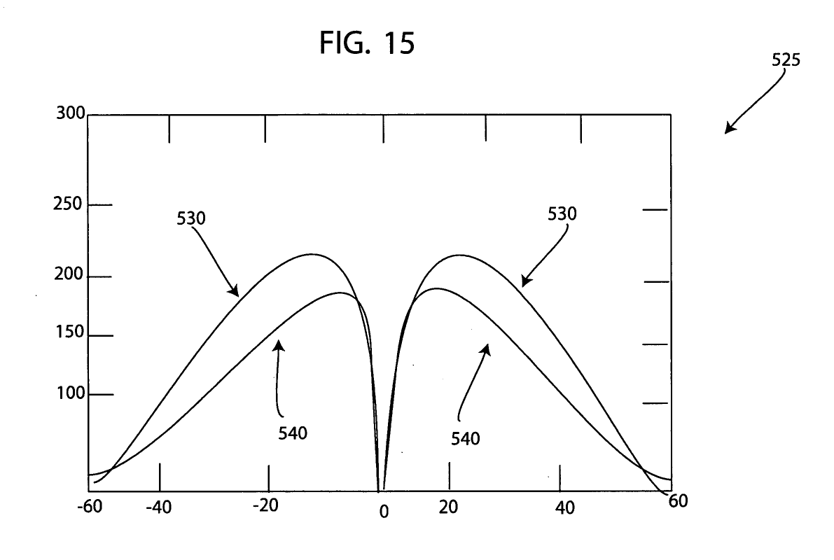

FIG. 14 shows a view of another embodiment of this device wherein dipoles 500 and 510 are shown along an inside rail of an associated track. Dipoles 500 and 510 can extend up to 60 m long each for a total of both dipoles being up to 120 m in length along the track. Each dipole or dipole set is powered to create an ambient magnetic field. The ambient magnetic field will create an associated magnetic reading which is shown in FIG. 15.

In this view FIG. 15 shows a graph 525 obtained from a computer model which includes a first reading of a contestant carrying a CCD 10 wherein loop 530 shows a reading for a contestant that is positioned at approximately 5 meters from an inside rail on the track. Loop 540 shows a reading for a second contestant that is positioned approximately 10 meters from an inside rail on a track. Using these readings, the system can determine a point at which a contestant crosses a particular point on a track such as the gap between the two dipoles 500 and 510 which is shown by the dip in the two loops at position or reading 0 on the graph. In addition, based upon the height or amplitude of these loop readings, the system can also determine the distance each competitor is located from the rail so that the exact position of each competitor is known either throughout the race or at particular points during the race such as at the finish line or at a halfway mark.

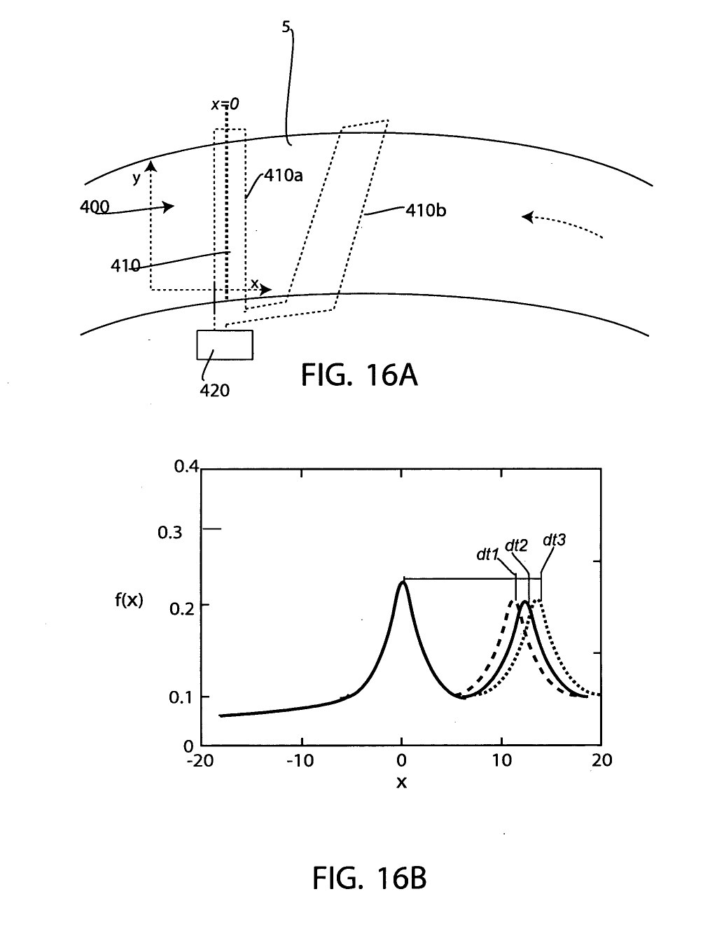

FIG. 16 shows another embodiment of the invention which includes a different loop system 400 wherein in this embodiment, the device includes a loop that is positioned underneath a track via a process called directional drilling wherein the equipment drills a tiny hole and pulls the cable through this hole so that the racetrack is not affected at all. In this embodiment, the wires can be placed approximately 1.5 meters below the track surface. FIG. 16 shows the shape of this loop 410, which includes a first loop 410a coupled to a second loop 410b wherein both loops are driven or powered by a loop driver 420. These loops or loop systems 400 can be placed around a track as shown by example in FIG. 1 at any point, but may be particularly placed at fraction points around a track such as the start, the ¼ mile marker, the ½ mile marker, the ¾ mile marker, the one mile marker and the finish line if the finish line is not on a fraction line.

Essentially, the loop is the shape of a large “V” with one arm 410a extending perpendicular to the longitudinal axis of the race track and the other arm 410b positioned at an angle relative to this first arm. Power can flow through the loop in a counter clockwise manner wherein this power can flow out from loop drive 420 and through loop 410b first and then flow through loop 410a and then back to loop driver 420. Using a computer simulation of the magnetic field readings the signal picked up by a CCD 10 sensor on a horse can have the shape shown in FIG. 16B.

With this view the solid line is the output of a sensor 100, or 300 in CCD 10 that travels along a track center. The dashed line is the reading that corresponds to the sensor 100, 300 on a contestant that is four meters from the center towards the inside, while the dotted line is a reading of a contestant that is four meters from the center towards the outside.

As the contestants move around a track and as the sensors move, all sensors will read two (2) peaks in the field. The second peak, which is due to the perpendicular arm 410a of the V shaped loop, will be the same x coordinate. The first peak, which is due to the slanted arm of the V shaped loop 410b will read as a different x coordinate depending on the sensor's proximity to the rail. Sensors closer to the rail will see the two peaks closer together, while ones on the outside will see them further apart.

Thus, each sensor records two values, the time of the second peak (T2), and the delay between the peaks (dT=T2−T1). This information is then reported to the base station. Time T2 is used directly for timing purposes. In this case, the base stations can calculate the average sensor speed based upon measurements of T2 at the previous and at the current point of call which is determined when the sensor crosses a center point of each loop 410a for each loop positioned around the track. As shown in the drawing, dt1 is for the contestant that is four meters from the center of the track surface towards the inside rail, dt2 is the time for the contestant at the center portion of the track, and dt3 is the time for the contestant four meters from the center of the track towards the outside rail.

Knowing dT and the speed of each contestant, the x distance or traveling distance between the peaks can be calculated. Then taking into account the geometry of the loops, the distance of the rail is calculated. In this case, if the x distance is larger, then the distance from the rail is calculated to be larger as well. If the x distance is smaller then the distance from the rail is also calculated to be smaller as well.

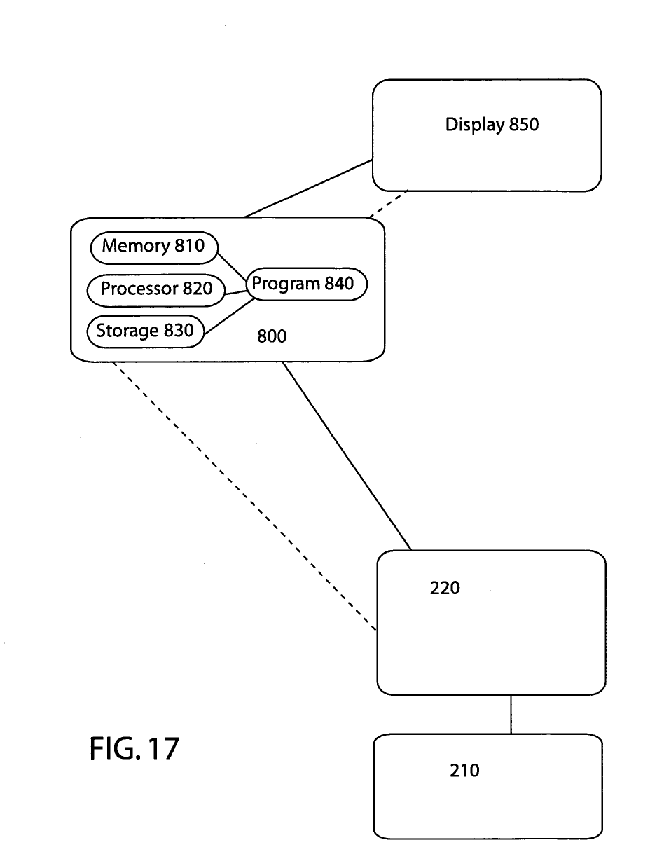

FIG. 17 shows a layout of a pc/server 800 which can be used to create interesting displays of the progress of a race on a racetrack. PC/server 800 can be in the form of any known pc or server and can include a memory device 810 a processor 820, a storage device 830 such as a hard drive and a program 840 which can be in the form of a set of instructions operating on pc/server 800. PC/server 800 receives information from indoor unit 220 relating to the position of each competitor in a race based upon the position of a competitor communication device 10. Program 840 can be used to compile the information received by PC/Server 800 so that it can create graphical images on a display 850.

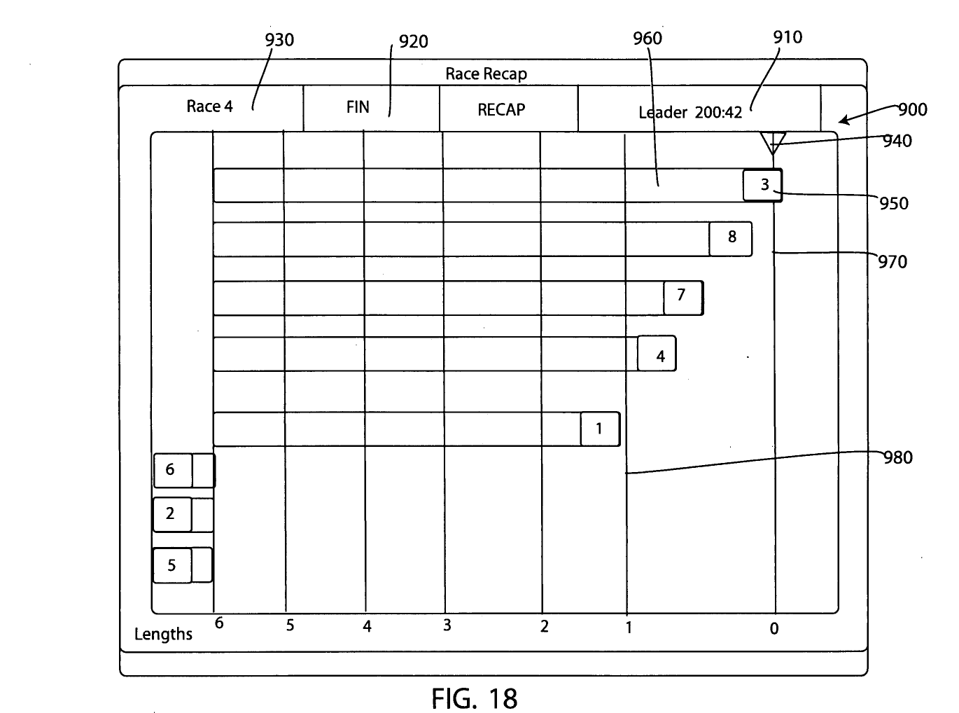

FIG. 18 shows a screen such as a television based graphical representation or display 900 which can be used to provide an instant race recap for each fraction and finish. In this case, a personal computer (PC) or central server 800 can be in communication with each competitor communication device via indoor unit 220 and outdoor unit 210 to receive the signals from each competitor communication device. PC/server 800 as shown in FIG. 17 can then be used to create an instant race recap via a video screen. This entire screen is a snapshot representation of all the competitors/CCD positions as a leader crosses a fraction line.

In this case, there is shown a graphical representation of the competitors in a race wherein this representation lists the leader time 910, the name of the fraction represented (¼, ½, ¾, FIN (finish) 920, a listing of the number of the race 930, and a marker 940 indicating the position of a fraction position on a track. Each competitor is represented by its race number 950 and also by a graphical bar 960 which extends across the screen and crosses different length lines 970 which is the finish line, and 980 which is the distance behind the lead horse separated by one horse length. These length lines 980 can be used to display a distance that a competitor is spaced behind another competitor. For example, in horse racing, the distance of other horses behind another horse can be calculated in lengths. In this case, these length lines would be helpful for handicappers in determining the distance that particular competitors are from a leader.

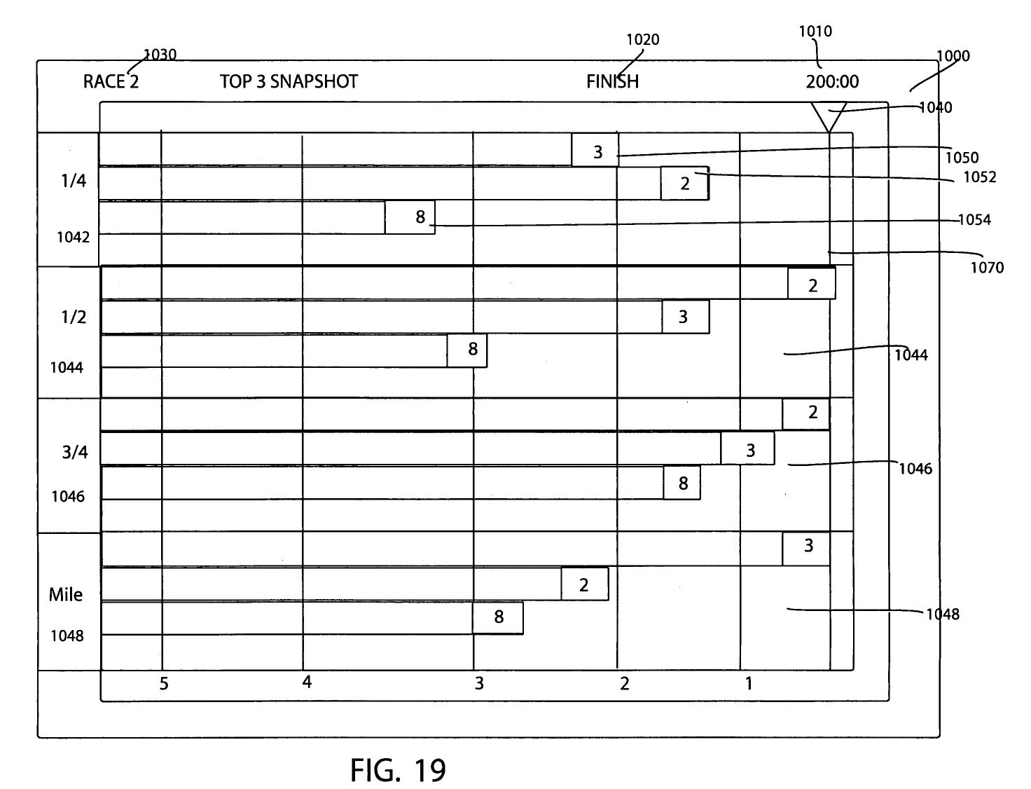

FIG. 19 denotes a television graphical representation of the top three (3) finishers (win, place, show) in horse racing throughout an entire race. This screen representation 1000 includes a time clock 1010, an indication of a race number 1030, and a position marker 1040 which marks the position of the leader in a race. In this single race, the positions of the first three competitors 1052, 1050, 1054 are shown for each of the race fraction periods. For example, the position of these competitors are shown at the ¼ mile fraction marker 1042, the ½ mile fraction marker 1044, at the ¾ mile fraction marker 1046, and also at the mile fraction marker 1048. In this case, the position of the three leading competitors are shown to provide an indication of a competitor in a win/place/show position.

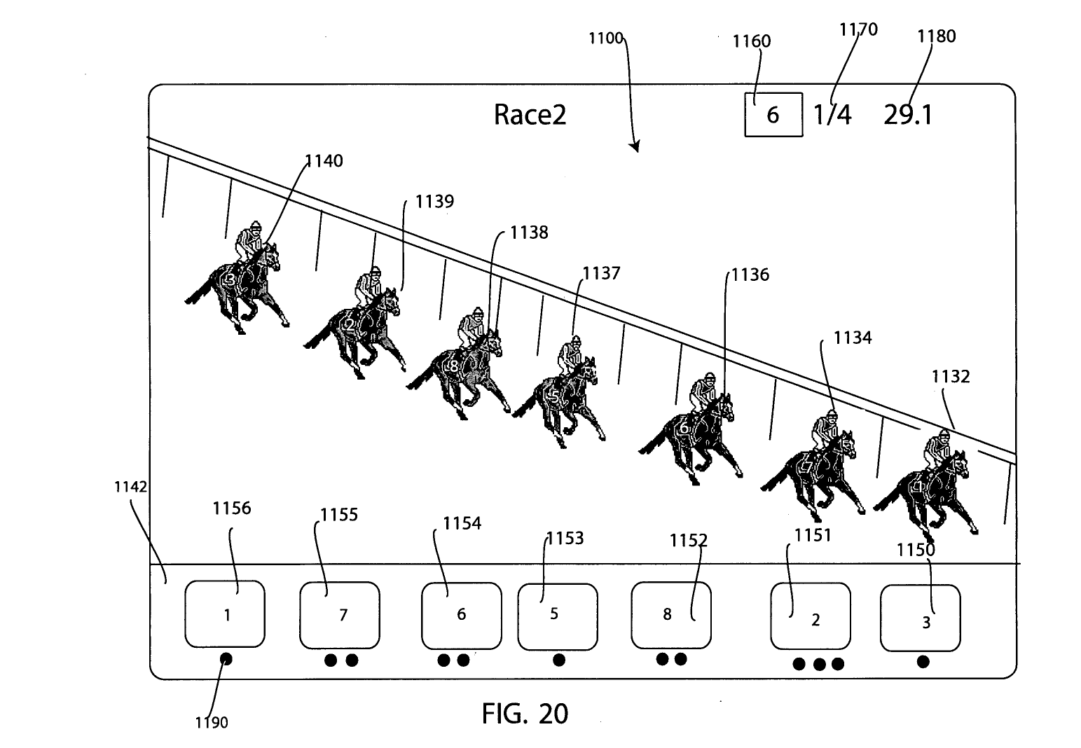

FIG. 20 shows a full field running order television screen which includes the actual live video screen of the race competitors and also a listing at the bottom of the screen of the order of all of these competitors in the race which may be more than represented in FIG. 20. This running order is shown by displaying from left to right a graphic of the competitors position in the race. For example, three is a series of competitors 1132, 1134, 1136, 1137, 1138, 1139, and 1140 shown in real time on a video screen. A listing of these competitors is then shown in a graphic bar 1142 which displays the order of these competitors extending from left to right. For example, competitor number 1 designated by number 1132 on the screen is positioned in lower graphic bar 1142 and shown by graphic 1156 and positioned in a far left position indicating that competitor number 1 is in a lead. Competitor number 7 is shown by graphic 1155 and is shown adjacent to graphic 1156. The remaining graphics 1150, 1151, 1152, 1153 and 1154 are used to show the order of these remaining competitors.

This screen also shows an indicator 1160 of the number of the horse in the lead at the previous fraction mark, the indicator for the previous fraction mark 1170, and the time period of the leader at the previous fraction mark 1180. Furthermore, there is also an indicator 1190 which indicates the placement of the horses via dots to indicate the distance of each horse in an average horse width from the inside rail. Each dot indicates that the horse is an average horse width from the rail. In this case, these indicators on all of the screens indicate both the length position and the width position of these competitors during the race.

Essentially, the competitor communication device 10 works with program 840 and PC/server 800 to create a system where there is an easier way to present instant information to viewers who wish to track and handicap races. The process can essentially follow the following steps: a timer on a competitor communication device is started with an absolute timer clock, the time on that device 10 is marked at the start of the race and then forwarded wirelessly to outdoor unit 210 wherein this information is then forwarded onto indoor unit 220. Indoor unit can then forward this information onto PC/server 800. This information is then forwarded onto display 800 to display this information on the different screens.

This system them provides a handicapper of races with an easy access to information relating to that race. In this case, the handicapper can then easily use this information to monitor or bet on future races.

Accordingly, while several embodiments of the present invention have been shown and described, it is to be understood that many changes and modifications may be made thereunto without departing from the spirit and scope of the invention as defined in the appended claims.

1. A system for determining a particular position of an individual contestant in a race on a track wherein the system comprises:
at least one transmitting loop disposed beneath the track and positioned at a particular position on the track, and for creating an ambient magnetic field;
at least one competitor communication device which can be coupled to each contestant and which can be used to read the ambient magnetic field; and
at least one remote base station, wherein said competitor communication device determines a contestant time as said contestant passes said at least one loop.

2. The system as in claim 1, wherein said loop comprises at least two loops.

3. The system as in claim 2, wherein said loop comprises at least one loop having at least one length extending substantially perpendicular to a running direction on a track and at least one loop having at least one length extending substantially offset from perpendicular to a running direction on a track.

4. The system as in claim 3, wherein said at least one competitor communication device comprises at least one microprocessor which contains a set of instructions which creates a unique identity for said at least one microprocessor identifying the contestant using the device.

5. The system as in claim 1, wherein said microprocessor contains a time division multiple access (TDMA) protocol to set a periodic time for transmission to and from said transceiver to said remote processing station to avoid collision or interference of a signal.

6. The system as in claim 1, further comprising an infrared system positioned adjacent to each of said at least one loop wherein said infrared system determines when a competitor crosses a path on said infrared system.

7. The system as in claim 1, further comprising at least one relay station for relaying and amplifying signals for transmitting information between said at least one competitor communication device and said at least one remote base station.

8. The system as in claim 1, wherein said loop having said length offset from perpendicular from the running direction of the track is used to determine the position of each contestant from an inside rail.

9. A system for charting the position of at least one contestant in a race comprising:
at least one transmitting loop disposed adjacent to a running surface on the track, said loop for creating an ambient magnetic field;
at least one competitor communication device which can be coupled to at least one contestant and which can be used to read the ambient magnetic field;
at least one remote base station, wherein said competitor communication device determines a contestant time as said contestant passes said at least one loop, and wherein this contestant time is forwarded to said at least one base station; and
at least one display, in communication with said at least one remote base station, wherein said display displays the position of the contestant in relation to the other contestants in the race.

10. The system as in claim 9, wherein said at least one display is in the form of screen including a graphical representation of a full field running order for each of the contestants in a race.

11. The system as in claim 9, wherein said at least one contestant comprises a plurality of contestants and said display includes a graphical representation of the top three finishers taken from said plurality of contestants at a plurality of different positions throughout an entire race.

12. The system as in claim 9, wherein said display includes a screen displaying a television based graphical representation which can be used to provide an instant race recap for each fraction and finish position for each contestant.

13. A process for tracking and reporting the position of contestants in a race comprising:
creating an ambient magnetic field in at least one position on a track;
attaching at least one individual contestant positioning device on at least one contestant, wherein said positioning device is equipped to measure the magnitude of said ambient magnetic field on said at least one contestant;
starting a race;
recording a position and time of said at least one contestant;
reporting said position and time of said at least one contestant on a display device.

14. The process as in claim 13, wherein said step of recording a position of said at least one contestant comprises recording a position of at least one contestant relative to an adjacent contestant.

15. The process as in claim 14, wherein said step of recording a position of said at least one contestant comprises comparing a position of at least one first contestant to at least one second contestant and then comparing a difference in distance to an average length of a competitor.

16. The process as in claim 14, wherein said step of recording a position and time of said at least one contestant includes recording a position of at least one contestant relative to an inside rail on a track.

17. The process as in claim 16, wherein said step of recording a position of said at least one contestant includes recording a position of at least one contestant relative to an inside rail and wherein said position is measured based upon an average width of a contestant.

18. The process as in claim 13, wherein said step of reporting a position of at least one contestant includes reporting on at least one display in the form of screen including a graphical representation of a full field running order for each of the contestants in a race.

19. The process as in claim 13, wherein said step of reporting a position of at least one contestant includes reporting a position of a plurality of contestants on a display which includes forming on said display a graphical representation of the top three finishers taken from said plurality of contestants at a plurality of different positions throughout an entire race.

20. The process as in claim 13, wherein said step of reporting a position includes providing a screen displaying a television based graphical representation which can be used to provide an instant race recap for each fraction and finish position for each contestant.
